(19) United States
(12) Patent Application Publication
(10) Pub. No.: US 2022/0274389 A1
(43) Pub. Date: Sep. 1, 2022

(54) METHOD FOR MANUFACTURING LAMINATE, LAMINATE, CARRIER, AND METHOD FOR MANUFACTURING THE CARRIER

(71) Applicant: PLANTICS HOLDING B.V., Arnhem (NL)

(72) Inventors: Wridzer Jan Willem BAKKER, Arnhem (NL); Hans Daniel KNEPPER, Arnhem (NL)

(73) Assignee: PLANTICS HOLDING B.V., Arnhem (NL)

(21) Appl. No.: 17/631,123

(22) PCT Filed: Jul. 16, 2020
(86) PCT No.: PCT/EP2020/070217

§ 371 Date: Jan. 28, 2022

(30) Foreign Application Priority Data
Aug. 2, 2019 (EP) 19189757.8

(51) Int. Cl. B32B 27/36; B32B 7/12

(52) U.S. Cl. CPC B32B 27/36; B32B 7/12; B32B 2255/26; B32B 2255/12; B32B 2250/02; B32B 2250/03; B32B 2250/40; B32B 2479/00; B32B 2607/00

(57) ABSTRACT

The invention pertains to a laminate comprising a panel and a carrier provided with a polyester derived from an aliphatic polyol with 2-15 carbon atoms and an aliphatic polycarboxylic acid with 3 to 15 carbon atoms, wherein the polyester has an extent of polymerization determined gravimetrically, of at least 0.6, in particular at least 0.7, more in particular at least 0.8, in some embodiments at least 0.9, the carrier being present on the panel, wherein the carrier (not calculating the polyester) has an areal weight of 5-200 g/m2 and the panel has a thickness of at least 0.2 mm. The invention also pertains to a method for manufacturing the laminate, to the carrier used therein, and to the method for manufacturing the carrier. The method according to the invention allows the manufacture of high-quality laminates at high velocity.

### FIELD OF THE INVENTION

The present invention pertains to a method for manufacturing a laminate comprising a panel and a polymer layer, wherein the polymer layer is of a specific type of biopolymer. The invention also pertains to laminates that can be obtained by the method according to the invention, and to intermediate products suitable for use in the laminates and methods according to the invention.

### BACKGROUND OF THE INVENTION

WO2012/140238 describes a laminate comprising a panel and a polymer layer, wherein the polymer layer is applied over at least part of the panel, the polymer layer comprising a polyester derived from an aliphatic polyalcohol with 2-15 carbon atoms and a polyacid, the layer having a thickness in the range of 10-4000 microns, wherein the aliphatic polyalcohol contains at least 50 mol. % of glycerol and the polyacid contains at least 30 wt. % of tricarboxylic acid. The laminate is manufactured by a method is which a panel is provided with a layer of a coating composition comprising the polyester and the coated panel is kept at a temperature of 20 to 200° C. for a period of 5 minutes to 5 days. In the examples, periods of 15 hours, three hours, and two hours are used. In commercial operation, laminate manufacture takes place at very high velocities. It has been found that the method described above is difficult to carry out at the high velocities applied commercially while still obtaining a good product. A further issue with the method described in WO2012/140238 is that liquid resin can sometimes cause stains on the surface layer, which is undesirable, especially in high-end applications. A further issue is that when the method is used to adhere panels to each other, the adhesion strength is not always sufficient.

There is need in the art for a method for manufacturing laminates using the biopolyester described in WO2012/140238, which method allows the manufacture of high-quality laminates at high velocity.

The present invention provides such a method.

### SUMMARY OF THE INVENTION

The invention pertains to a method for manufacturing a laminate comprising a panel and a polymer layer which comprises the steps of
providing a carrier provided with a polyester derived from an aliphatic polyol with 2-15 carbon atoms and an aliphatic polycarboxylic acid with 3 to 15 carbon atoms, the polyester having an extent of polymerization, which is the ratio of the fraction of functional groups that have reacted to the maximum of those functional groups that can react, of at least 0.10, the carrier having an areal weight of 5-200 g/m2,
applying said carrier onto a panel, the panel having a thickness of at least 0.2 mm to form a laminate of the panel and the carrier, and
subjecting said laminate of panel and carrier to a curing step.

The invention also pertains to a laminate comprising a panel and a carrier provided with a polyester derived from an aliphatic polyol with 2-15 carbon atoms and an aliphatic polycarboxylic acid with 3 to 15 carbon atoms, wherein the polyester has an extent of polymerization determined gravimetrically, of at least 0.6, in particular at least 0.7, more in particular at least 0.8, in some embodiments at least 0.9, the carrier being present on the panel, wherein the carrier (not calculating the polyester) has an areal weight of 5-200 g/m2 and the panel has a thickness of at least 0.2 mm.

The invention further pertains to a carrier provided with polyester, suitable for use in the method of this invention, comprising a carrier material and a polyester derived from an aliphatic polyol with 2-15 carbon atoms and an aliphatic polycarboxylic acid with 3 to 15 carbon atoms or monomer precursors thereof, the polyester having an extent of polymerization of at least 0.1, in particular at least 0.20, and at most 0.95, in particular between 0.25 and 0.9, or between 0.5 and 0.85, wherein the carrier, not including the polyester, has an areal weight of 5-200 g/m2.

The invention further pertains to a method for manufacturing a carrier provided with polyester according to the invention, comprising the steps of
contacting a carrier material, preferably in the form of a sheet or strip with a liquid medium comprising a polyester derived from an aliphatic polyol with 2-15 carbon atoms and an aliphatic polycarboxylic acid with 3 to 15 carbon atoms or monomer precursors thereof, to form a carrier provided with polyester or precursors thereof, and
optionally subjecting the carrier provided with polyester or precursors thereof to a curing step.

### DETAILED DESCRIPTION

The present invention is thus characterized by the use of a carrier provided with polyester in the manufacture of the laminate. It is a key feature of the present invention that the carrier has an areal weight of 5-200 g/m2 (determined in the absence of polyester). The carrier is thus relatively thin and relatively low weight. This allows the carrier to be, as the name states, a carrier for the polyester. On the other hand, the panel has a thickness of at least 0.2 mm, and may be much thicker, depending on the specific application. The panel is the part of the laminate that will provide structural integrity to the laminate.

The use of a carrier provided with the specified polyester allows the separation of the laminate manufacturing step from the carrier manufacturing step. This makes it possible to carry out the two steps at different rates, while still using an attractive polyester. This is an improvement over the process described in WO2012/140238. Additionally, the use of a carrier as described herein makes it possible to provide attractive surface properties to a laminate. It further makes it possible to obtain a laminate with attractive properties. Further advantages of the present invention and specific embodiments thereof will become apparent from the further specification.

In the present application the extent of polymerization of the monomers will be expressed as conversion, which is the ratio of the fraction of functional groups that have reacted at a certain point in time to the maximum of those functional groups that can react.

The conversion can be determined from the acid value of the reaction mixture as compared to the theoretical acid value of the total of the monomers present. This method is particularly suitable for determining the extent of conversion of the starting polyester. Conversion can also be determined gravimetrically, from the water loss that occurs during the polymerization reaction. This method is particularly suitable for determining the extent of polymerization in the final product.

The polymer as it is present on the carrier when it is used in forming the laminate has an extent of polymerization, determined by way of the acid value, of at least 0.10, in particular at least 0.20. The extent of polymerization is generally at most 0.95. A preferred range may be between 0.25-0.90. It may be preferred for the extent of polymerization to be in the range of 0.5-0.85.

In the final product obtained after the curing step of the laminate of panel and carrier provided with polyester, the extent of polymerization, determined gravimetrically, is higher than the extent of polymersiation of the polymer before the curing step. It will generally be at least 0.6, in particular at least 0.7, more in particular at least 0.8, in some embodiments at least 0.9.

The present invention makes use of a carrier provided with the specific polyester with a specific extent of polymerization. It has been found that the use of such a polyester-containing carrier enables the manufacture of laminates at high velocities and in high quality. High quality in this context means a high reproducibility. Other advantages of the present invention and specific embodiments thereof will become clear from the further specification.

The Polymer

The present invention makes use of a polyester derived from an aliphatic polyol with 2-15 carbon atoms and an aliphatic polycarboxylic acid with 3 to 15 carbon atoms.

The aliphatic polyalcohol used in the present invention comprises at least two hydroxyl groups, in particular at least three hydroxyl groups. In general, the number of hydroxyl groups will be 10 or less, more in particular 8 or less, or even 6 or less, in particular two or three. The polyalcohol has 2-15 carbon atoms More in particular, the polyalcohol has 3-10 carbon atoms. It is preferred for the polyalcohol to contain no heteroatoms. More in particular the polyalcohol is an aliphatic polyalkanol containing only C, H, and O atoms. It is preferred for the polyalcohol to contain no non-carbon groups than hydroxyl groups. In a preferred embodiment of the present invention the polyalcohol contains a relatively large number of hydroxyl groups in comparison with its number of carbon atoms. For example, the ratio between the number of hydroxyl groups and the number of carbon atoms ranges from 1:4 (i.e. one hydroxyl group per four carbon atoms, or 8 carbon atoms for a dialcohol) to 1:1 (i.e. 1 hydroxyl groups per carbon atom). In particular, the ratio between the number of hydroxyl groups and the number of carbon atoms ranges from 1:3 to 1:1, more specifically, from 1:2 to 1:1. A group of specifically preferred polyalcohols is the group wherein the ratio ranges from 1:1.5 to 1:1.

Compounds wherein the ratio of hydroxyl groups to carbon atoms is 1:1 are considered especially preferred.

Examples of suitable polyalcohols include the trialcohols selected from glycerol, sorbitol, xylitol, and mannitol, and dialcohols selected from 1,2-propanediol, 1,3-propanediol, and 1,2-ethanediol The use of compounds selected from the group of glycerol, sorbitol, xylitol, and mannitol is preferred, with the use of glycerol being particularly preferred.

The preference for glycerol is based on the following: In the first place glycerol has a melting point of 20° C., which allows easy processing, in particular as compared to xylitol, sorbitol, and mannitol, which all have melting points well above 90° C. Further, it has been found that glycerol gives a polymer of high quality, and thus combines the use of an easily accessible source material with good processing conditions and a high-quality product Mixtures of different types of alcohol may also be used.

It is preferred, however, for the polyalcohol to consist for at least 50 mole % of glycerol, xylitol, sorbitol, or mannitol, in particular of glycerol, preferably at least 70 mole %, more in particular at least 90 mole %, or even at least 95 mole %. In one embodiment the polyalcohol consists essentially of glycerol.

The use of glycerol which is a side product of the manufacture of biodiesel by the transesterification reaction of glycerides with mono-alcohols is a specific embodiment of the present invention Suitable monoalcohols include C1-C10 monoalcohols in particular C1-C5 monoalcohols, more in particular C1-C3 monoalcohols, specifically methanol The glycerides are mono-di- and esters of glycerol and fatty acids, the fatty acids generally having 10-18 carbon atoms, Suitable processes for manufacturing biodiesel with associated glycerol are known in the art.

The aliphatic polycarboxylic acid used in the present invention comprises at least two carboxylic acid groups, in particular at least three carboxylic acid groups. In general, the number of carboxylic acid groups will be 10 or less, more in particular 8 or less, or even 6 or less. The polycarboxylic acid has 3-15 carbon atoms More in particular, the polycarboxylic acid has 3-10 carbon atoms. It is preferred for the polycarboxylic acid to contain no N or S heteroatoms. More specifically it is preferred for the polycarboxylic acid to contain no non-carbon groups than the carboxylic acid groups. More in particular the polycarboxylic acid is an aliphatic polycarboxylic acid containing only C, H, and O atoms.

In one embodiment a dicarboxylic acid is used. The dicarboxylic acid, if used, may be any dicarboxylic acid which has two carboxylic acid groups and, in general, at most 15 carbon atoms. Examples of suitable dicarboxylic acids include itaconic acid, malic acid, succinic acid, glutaric acid, adipic acid and sebacic acid. Itaconic acid and succinic acid may be preferred.

In one embodiment a tricarboxylic acid is used. The tricarboxylic acid, if used, may be any tricarboxylic acid which has three carboxylic acid groups and, in general, at most 15 carbon atoms Examples include citric acid, isocitric acid, aconitic acid (both cis and trans), and 3-carboxy-cis,cis-muconic acid. The use of citric acid is considered preferred, both for reasons of costs and of availability.

Where applicable the polycarboxylic acid may be provided as a whole or in part in the form of an anhydride, e.g., citric acid anhydride.

It has been found that the use of tricarboxylic acid results in a polyester with attractive properties. Therefore, in one embodiment, the polyacid comprises at least 10 wt. % of tricarboxylic acid, whether or not in combination with dicarboxylic acids, other tricarboxylic acids, and mixtures thereof In one embodiment the polyacid comprises at least 30 wt. % of tricarboxylic acid, calculated on the total amount of polyacid, preferably at least 50 wt. %. In one embodiment the amount of tricarboxylic acid is at least 70 wt. %, more in particular at least 90 wt. %, or even at least 95 wt. %. In one embodiment the polyacid consists essentially of tricarboxylic acid, wherein the word essentially means that other acids may be present in amounts that do not affect the properties of the material

In another embodiment of the invention the acid comprises at least 10 wt. % of dicarboxylic acid, calculated on the total amount of acid, preferably at least 30 wt. %, more preferably at least 50 wt. %. In one embodiment the amount of dicarboxylic acid is at least 70 wt. %.

In one embodiment the acid comprises a combination of at least 10 wt. % of tricarboxylic acid and at least 2 wt. % of dicarboxylic acid, more in particular at least 10 wt. % of tricarboxylic acid and at least 5 wt. % of dicarboxylic acid, or at least 10 wt. % of tricarboxylic acid and at least 10 wt. % of dicarboxylic acid. In this embodiment the weight ratio between the two types of acid may vary within wide ranges, depending on the properties of the desired material In one embodiment, the dicarboxylic acid makes up between 2 and 90 wt. % of the total of dicarboxylic and tricarboxylic acid, in particular between 5 and 90 wt. %, more in particular between 10 and 90 wt. %, depending on the properties of the desired material It is noted that the preferred ranges for the tricarboxylic acid specified above are also applicable to this embodiment. It has been found that the use of a tricarboxylic acid, in particular citric acid, results in the formation of a high-quality composite material, in particular in combination with the use of a trialcohol such as glycerol.

Not wishing to be bound by theory we believe that there are a number of reasons why the use of a tri-acid, in particular in combination with a tri-ol results in the formation of a high-quality composite material In the first place, the use of a tri-acid, in particular in combination with a tri-ol, makes for a highly crosslinked polymer, resulting in increased strength.

The molar ratio between the polyalcohol and the polyacid will be governed by the ratio between the number of reacting groups in the alcohol(s) and acid(s) used. In general, the ratio between the number of OH groups and the number of acid groups is between 5:1 and 1:5. More in particular, the ratio may between 2:1 and 1:2, more specifically between 1.5:1 and 1:1.5, more preferably between 1.1:1 and 1:1.1. The theoretical molar ratio is 1:1.

The polymer is formed by combining the alcohol and the acid to form a liquid phase. Depending on the nature of the compounds this can be done, e.g., by heating a mixture of components to a temperature where the acid will dissolve in the alcohol, in particular in glycerol. Depending on the nature of the compounds this may be, e.g., at a temperature in the range of 20-200° C., e.g., 40-200° C., e.g. 60-200° C., or 90-200° C. In one embodiment, the mixture may be heated and mixed for a period of 5 minutes to 2 hours, more specifically 10 minutes to 45 minutes, at a temperature of 100-200° C., in particular 100-150°, more in particular at a temperature in the range of 100-140° C.

Optionally a suitable catalyst can be used for the preparation of the polyester. Suitable catalysts for the manufacture of polyester are known in the art. Preferred catalysts are those that do not contain heavy metals. Useful catalysts are strong acids like, but not limited to, hydrochloric acid, hydroiodic acid and hydrobromic acid, sulfuric acid (H2SO4), nitric acid (HNO3), chloric acid (HClO3), boric acid, perchloric acid (HClO4), trifluoroacetic acid, p-sulphonic acid, and trifluoromethanesulfonic acid. Catalysts like Zn-acetate and Mn-acetate can also be used, although they may be less preferred.

In one embodiment compounds are added to increase the interaction of the polymer with hydrophobic materials, or to increase the water resistance of the final product. Suitable compounds include for example, C5 to C22 saturated or unsaturated fatty acids or salts thereof, C5 to C22 saturated or unsaturated fatty alcohols, and dimeric and trimeric fatty acids or alcohols. For example, glycerol monostearate, triethyl citrate, and valeric acid can been used in this invention.

The compounds to increase hydrophobicity will generally be applied in an amount of 0.1-5 wt. %, calculated on the amount of the polymer, more in particular in an amount of 0.3-3 wt. %.

The Carrier Provided with Polyester

In the present invention a carrier is used provided with the polyester. The invention thus also pertains to a carrier provided with polyester, comprising a layer of a carrier material and a polyester derived from an aliphatic polyol with 2-15 carbon atoms and an aliphatic polycarboxylic acid with 3 to 15 carbon atoms or monomer precursors thereof, the polyester having an extent of polymerization of at least 0.1.

The carrier provided with the polyester may have any suitable size or shape, depending, for example, on whether it is desired to cover the entire surface of the panel with the polymer layer. The use of sheets or strips is considered preferred.

In general, the carrier provided with the polyester generally has a thickness in the range of 0.01 mm to 1 mm. Depending on the application, the carrier provided with the polyester generally has a width in the range of 1 mm to 2 metres. The length of the carrier is broader than the width, and may be infinite is the carrier is applied from a roll.

If the carrier provided with polyester is intended as an outer layer of the laminate, that is, a layer which will not be covered with further layers, it will generally be desired to cover a substantial part of the panel with the carrier provided with polyester, e.g., at least 60% of the surface, or at least 70% of the surface, or at least 80% of the surface, or at least 90% of the surface, or at least 95% of the surface. In this case it is preferred to use a single sheet of carrier provided with polyester to cover the panel, to give the best possible visual appearance.

Where the carrier provided with polyester is intended to serve as a bonding layer between two panels, it is possible to cover a substantial part of the panel with the carrier provided with polyester as described above, using one or more sheets or strips of carrier provided with polyester.

Where the carrier provided with polyester is intended to serve as a bonding layer between two panels it is also possible to provide only part of the surface of the panel with the carrier provided with polyester, e.g., between 10 and 60%. In the latter case, the carrier provided with polyester can, e.g., be in the form of a number of spaced apart strips or sheets, to ensure homogeneous binding of the panels.

The carrier may be of any material to which the polyester will adhere, whether through absorption into the material, or through physical or chemical interaction. Suitable materials include, for example film layers, fiber-based layers, including woven, non-woven, and knitted layers, and layers of parallel-oriented fibers, e.g., in the form of sheets or strips as desired. The nature of the carrier is not limited. Suitable materials include, for example, layers or strips of cellulose-based materials, e.g., paper sheets such as Kraft-paper and other papers, fabric layers of natural or synthetic fibers, polymer sheet layers, etc.

In one embodiment of the present invention, the carrier is porous. In the context of the present specification this means that the polyester or a precursor therefor can be absorbed into the carrier. This may, e.g., be the case for paper carriers.

The carrier (not containing the polyester) has an areal weight of 5-200 g/m². If the areal weight is below 5 g/m², the material will be so thin that its processability will be hampered. If the areal weight is above 200 g/m², the carrier will make up a substantial portion of the laminate, which is not desired. It may be preferred for the areal weight to be in the range of 20-120 g/m².

The carrier (not containing the polyester) is generally flexible. That is, it can be rolled into a tube with a diameter of 5 cm or less followed by unrolling without being damaged. In contrast, the panels used in the present invention are generally not flexible as defined above. Where the carrier provided with polymer is intended to be the outer surface of the laminate, it may be attractive to provide the carrier with a desired surface appearance, e.g., by providing a desired color, pattern, print, or texture.

It may be attractive for the carrier provided with polymer to be flexible, so that storage and processing from a roll is possible. It is possible to obtain a flexible material by selecting a flexible starting material, using appropriate amounts of polymer and suitable polymerization conditions. It is within the scope of the skilled person to select these parameters.

The carrier provided with polyester may be manufactured via the following steps: contacting a carrier material, preferably in the form of a sheet or strip, with a liquid medium comprising a polyester derived from an aliphatic polyol with 2-15 carbon atoms and an aliphatic polycarboxylic acid with 3 to 15 carbon atoms or monomer precursors thereof, to form a carrier provided with polyester or precursors thereof, and, if so desired, subjecting the carrier provided with polyester or precursors thereof to a curing step.

The liquid medium comprises polyester or polyester precursors. In general it is preferred for the polyacid and polyalcohol monomers to have polymerized to some extent, e.g., to an extent of conversion, determined by way of the acid value, of between 0.1 and 0.6, in particular in the range of 0.2-0.55, as determined via the acid value.

In one embodiment, the liquid medium contains water, to reduce the viscosity of the medium to a value at which impregnation can easily be carried out. In this case, it may be preferred for the medium to contain 10-50 wt. % of water.

The liquid medium can comprise further components. Examples include catalysts, fillers, colorants, and additional polymers. Further possible components will be apparent to the person skilled in the art.

The liquid medium comprising polyester or polyester precursors may be applied via methods known in the art, such as dipping, spraying, flowing, rolling, brushing, or cascading. Rolling, spraying and dipping have been found to be particularly suitable.

The carrier layer provided with the liquid medium may be subjected to a drying step or curing step. The extent of polymerization of the polyester after the curing step will be higher than the extent of polymerization of the polyester on the carrier before the curing step.

The crux of the curing step is that the polyester is at reaction temperature, e.g., a product temperature of 80-250° C., in particular between of 100-200° C., more in particular 100-180° C. Curing can be carried out using heating technology known in the art, e.g., in in an oven with an oven temperature from 80° C. up to 450° C. Different types of technology and apparatus may be used, including but not limited to convection ovens, microwave ovens, infra red ovens, induction oven, hot-air ovens, conventional baking ovens and combinations thereof. Curing can be done in a single step, or in multiple steps, depending on the desired application. The curing times range from 5 seconds up to 2 hours, depending on the application and on the type of oven and temperature used. It is within the scope of a person skilled in the art to select suitable curing conditions, depending on the desired application and desired properties. It may be preferred to carry out the curing step in an inert gas atmosphere, e.g., under nitrogen, in particular in the absence of oxygen. The use of an inert atmosphere allows the use of higher curing temperatures while limiting the occurrence of undesired oxidation reactions. It is within the scope of the skilled person to select reaction conditions which are suitable to obtain the desired extent of polymerization.

It may be attractive to manufacture the carrier provided with polymer via a roll-to toll process, wherein carrier material is withdrawn from a roll and provided with polymer, the carrier provided with polymer is subjected to a curing step, and to reach a suitable extent of polymerization, and the resulting product is in the form of a roll.

In the carrier provided with polymer that can be obtained using the method described above the polymer as it is present on the carrier has an extent of polymerization, determined by way of the acid value, of at least 0.10, in particular at least 0.20. The extent of polymerization is generally at most 0.95. A preferred range may be between 0.25-0.90. It may be preferred for the extent of polymerization to be in the range of 0.5-0.85.

In general, the carrier provided with polyester has an areal weight in the range of 50-750 gram/m², in particular in the range of 100-500 g/m².

In general, the polymer layer of the carrier provided with polymer will be in the range of 20-500 micron, in particular in the range of 50-250 micron. These values are for a single polymer layer.

In one embodiment, polyester is present on both outer surfaces of the carrier. In general in this case, the carrier makes up 2-70 wt. % of the total of carrier and polyester. Lower carrier contents, corresponding to higher contents of polyester calculated on the weight of carrier provided with polyester, are considered advantageous in cases where the polyester-containing carrier is sandwiched between two panels to serve as an adhesive. Lower carrier contents, corresponding to higher contents of polyester calculated on the weight of carrier provided with polyester, can also be advantageous in the case the carrier provided with the polyester is to be provided as surface layer on a laminate, where the surface properties are to be provided by the polyester. Therefore, it is considered preferred for the carrier to make up 2-50 wt. % of the total of carrier and polyester, in particular 2-40 wt. %, in some embodiments 2-30 wt. %, or even 2-25 wt. %.

In another embodiment, one of the surfaces of the carrier is provided with the polyester while the other surface of the carrier is free of polyester. In this embodiment, the carrier provided with polyester is used to apply a surface structure, in particular a surface layer with a specific outer appearance onto a panel. In general in this case, the carrier makes up 20-95 wt. % of the total of carrier and polyester.

In the present invention, the carrier layers are intended to serve as carriers for the polymer and in some cases, where the carrier layer is an outer layer, to provide a specific surface structure to the laminate. Thus, the carrier layer(s) are not intended to provide substantial thickness to the laminate. Thus, in one embodiment, the total thickness of the carrier layers not including the polymer is less than 40% of the total thickness of the laminate not including the polymer. It is preferred for the total thickness of the carrier layers not including the polymer to be less than 30% of the total thickness of the laminate not including the polymer, in particular less than 25%. As a minimum value a ratio of at least 0.1% may be mentioned.

It is possible for the carrier to be provided with the polyester in a single step of in multiple steps. If the polyester is provided in multiple steps, the composition of the polyester in the various steps may be the same or different.

The Laminate and its Manufacture

In the method according to the invention, the carrier provided with polymer discussed above is applied over at least part of the surface of a panel to form a laminate of the panel and the carrier, and the laminate of panel and carrier is subjected to a curing step.

In one embodiment, the carrier provided with polymer is present on the outer surface of the laminate. In this embodiment, the carrier may serve to improve the appearance of the surface, to protect it from outside influences, e.g., from scratching, to create a repelling layer, e.g., a water-repelling layer or a chemical resistant layer, and/or to provide additional properties, such as attractive visual or tactile properties.

In one embodiment of the present invention, a second panel is applied over at least part of the carrier. In this embodiment the carrier is in effect used as an adhesive.

The panels used may be the same or different. In one embodiment the—or at least one of the—panels in the laminate comprises a ceramic material, wherein ceramic includes glass. In one embodiment the—or at least one of the—panels in the laminate comprises metal, e.g., a metal sheet. In one embodiment the—or at least one of the—panels in the laminate comprises wood or a wood-based material.

In general, in the present invention, the panel will be made of a different material than the carrier. For example, in one embodiment, the—or at least one of the—panels in the laminate is selected from the group of wood panels, fiberboard panels, particle board panels, HDF panels, and MDF panels, while the carrier is selected from paper.

The panel used in the present invention has a thickness of at least 0.2 mm. There is no technical upper limit to the thickness of the panel. An upper limit of 25 cm may be mentioned as an example. Preferred thickness ranges for specific embodiments will be discussed below.

In one embodiment, the laminate comprises a single panel provided on one or both faces with a carrier provided with polymer. In this case, the panel may be relatively thick, e.g., at least 5 mm, in particular at least 7 mm. A suitable range may be 5 mm to 3 cm. There is no technical upper limit to the thickness of the panel. An upper limit of 10 cm may be mentioned as an example. Suitable panels may, e.g., be wood-based, such as materials derived from fiberboards, particle boards, HDF, MDF, etc. This embodiment of the present invention provides an alternative for, e.g., plywood materials known in the art.

In this embodiment, polymer may be present on one side of the panel the carrier may be provided with polymer on one side, i.e., the side facing the panel, or on both sides. In the latter case, the outer polymer layer of the laminate is intended to provide specific surface properties to the laminate.

This embodiment of the present invention finds many uses, e.g., in building applications and furniture, transport, etc.

In one embodiment the laminate comprises a stack of panels with carrier layers sandwiched between the panels, and/or applied on one or more outer surfaces of the laminate.

In this embodiment the laminate may, e.g., be a stack of wood or wood-based panels with intermediate carrier layers. For example, the laminate may be a multiplex-type material comprising 2-20 wood-based panels, for example 3-10 wood-based panels, with a thickness of, e.g., 0.2-5 mm, in particular 0.5-3 mm. In this embodiment, polymer will be present on both sides of the intermediate carrier layers.

In one embodiment the carrier layers sandwiched between the wood-based layers have a thickness of 10-500 microns, more in particular in the range of 10-100 microns.

Carrier layers may or may not be applied on one or more outer surfaces of the laminate. In one embodiment, carrier layers are applied to the outer surfaces of the laminates. In one embodiment, the carrier layers on the outside of the laminate have a thickness of, for example, 20-2000 microns, in particular 50-400 microns. In this embodiment, polymer may be present on one side of the carrier, i.e., the side facing the panel, with the other side being free from polymer. It is also possible that polymer is present on both sides of the carrier. In the latter case, the outer polymer layer of the laminate is intended to provide specific surface properties to the laminate.

In the method of the invention carrier provided with polymer as discussed above is applied onto a panel, to form a laminate of the panel and the carrier. This can be done my any method known in the art and requires no elucidation here.

In one embodiment, the carrier provided with polymer is unrolled from a roll and applied to a panel, where applicable followed by the application of one or more further panels, whether or not already provided with carrier provided with polymer.

The laminate of panel and carrier provided with polymer is then subjected to a curing step, to increase the extent of polymerization of the polymer. During the curing step, the polyester is at reaction temperature, e.g., a product temperature of 80-250° C., in particular between of 100-200° C., more in particular 100-180° C. Curing can be carried out using heating technology known in the art, e.g., in in an oven with an oven temperature from 80° C. up to 450° C.

Different types of technology and apparatus may be used, including but not limited to convection ovens, microwave ovens, infra red ovens, induction oven, hot-air ovens, conventional baking ovens and combinations thereof. Curing can be done in a single step, or in multiple steps, depending on the desired application. The curing times range from 5 seconds up to 2 hours, depending on the application and on the type of oven and temperature used. It is within the scope of a person skilled in the art to select suitable curing conditions, depending on the desired application and desired properties. It may be preferred to carry out the curing step in an inert gas atmosphere, e.g., under nitrogen, in particular in the absence of oxygen. The use of an inert atmosphere allows the use of higher curing temperatures while limiting the occurrence of undesired oxidation reactions. It is within the scope of the skilled person to select reaction conditions which are suitable to obtain the desired extent of polymerization.

In the final product, the extent of polymerization, determined gravimetrically, will generally be at least 0.6, in particular at least 0.7, more in particular at least 0.8, in some embodiments at least 0.9.

Where a further panel is present over at least part of the carrier provided with polymer, it may be preferred to apply pressure to the thus-formed stack, during the entire curing step, or during part thereof, especially the first part. In this embodiment, a pressure is applied which generally is in the range of 1-100 bar, in particular 5-50 bar, more in particular 10-20 bar.

The invention also pertains to a laminate comprising a panel and a carrier provided with a polyester derived from an aliphatic polyol with 2-15 carbon atoms and an aliphatic polycarboxylic acid with 3 to 15 carbon atoms, wherein the polyester has an extent of polymerization determined gravimetrically, of at least 0.6, in particular at least 0.7, more in particular at least 0.8, in some embodiments at least 0.9.

In one embodiment, the laminate consists of a single panel provided on one or both faces with a carrier provided with polymer. In one embodiment the laminate comprises at least two panels with a carrier provided with a polyester sandwiched between the two panels, for example, 2-20 panels with carrier provided with a polyester sandwiched between the panels, wherein optionally one of both outer faces of the laminate are provided with a carrier provided with polymer.

The panels used in the present invention, and the laminates obtained therefrom, may have any shape. Examples include plates, but the invention also pertains to laminates with a three-dimensional (=non-flat) shape. Where two or more panels are used, they may have the same shape, e.g., in the case of plywood type materials, but the shapes may also be different.

If so desired, the laminates obtained by the process according to the invention may be subjected to further treatments, e.g., the provision of further layers to provide additional properties, e.g., additional resistance to water or chemicals.

As will be evident to the skilled person, features described for one aspect of the present invention, e.g., the carrier provided with polymer, will also apply to other aspects of the present invention, e.g., the laminate, unless they are clearly incompatible.

The present invention will be elucidated by the following examples, without being limited thereto or thereby.

### EXAMPLE 1

### Preparation of Carriers with Polymer

A polymer was prepared as follows: 1.0 kg of >99% pure glycerol and 2.0 kg of citric acid (purity>99%) were put in a stirred and heated reactor. Also 9 g of boric acid (>99% purity) was added. This mixture was heated up in about 15 minutes until 135° C. and kept at that temperature for 15 minutes. Then, tap-water was added until the polymer concentration was 80 or 90 wt. %, and the mixture was cooled down to room temperature. The polymer had a conversion of 0.48. This recipe was repeated as often as necessary to obtain the desired amount of polymer solution.

Various paper carrier sheets were provided with polymer on both sides as follows: A sheet of paper carrier material was dipped into the polymer solutions described above. After dipping, the paper carrier sheets were allowed to dry for 60 minutes at ambient temperature and then cured in an oven for 60 minutes at 150° C. These cured sheets (see Table 1) were used as an adhesive layer between panels and as top layers on laminates (see Example 2 and 3)

Properties of the starting paper carrier materials and after providing these carriers with polymer are given in Table 1.

TABLE 1

| | | areal weight | thickness | areal | thickness | |
|---|---|---|---|---|---|---|
| | | before | before | weight after | after | |
| | | polymer | polymer | polymer | polymer | |
| | | application | application | application | application | extent of |
| sample | | (g/m2) | (mm) | (g/m2) | (mm) | polymerization |
| 1 | white | 86 | 0.1 | 271 | 0.28 | 0.84 |
| | printer | | | | | |
| | paper* | | | | | |
| 2 | Kraft | 47 | 0.08 | 176 | 0.21 | 0.82 |
| | paper* | | | | | |
| 3 | Kraft | 46 | 0.08 | 374 | 0.31 | 0.79 |
| | paper** | | | | | |

*20% water added water to polymer
**10% water added to polymer

### EXAMPLE 2

### Use as Adhesive Layer

The cured papers carriers described in Example 1 were used as adhesive to glue 3-5 birchwood panels (1.4 mm thick) together, to form laminates. The laminates were manufactured as follows. Paper carriers were sandwiched between the panels, and the resulting stack was pressed for 10 minutes at 150° C. and 15 bar, and then further cured for 60 minutes at 135° C. Also, laminates were made with a lower pressure (7 bars), and a longer pressing time (20 minutes)

The panels in the resulting laminates ware firmly glued together with a strength comparable or higher than commercial birchwood laminates. The appearance of the outsides panels was as the original birch wood panels and without any stains.

### EXAMPLE 3

### Carrier with Polymer as Top Layer on Laminate

The cured paper carriers (see Table 1) were also used to put on top of the laminates made as described in Example 2. They were pressed for 5 minutes, at a temperature of 150° C. This resulted in a transparent, hard, homogenous, and smooth polymer top layer. The hardness of the top layer was between 78 and 82 Shore D. For comparison, Melamine which is often used as top layer in this field has a hardness of 80 Shore D.

1. A laminate comprising:
one or panels, and
a carrier on each said panel, said carrier being provided with a polyester derived from an aliphatic polyol with 2-15 carbon atoms and an aliphatic polycarboxylic acid with 3 to 15 carbon atoms,
wherein the polyester has an extent of polymerization determined gravimetrically, of at least 0.6, the carrier has an areal weight of 5-200 g/m², said areal weight not including the polyester, and said panel has a thickness of at least 0.2 mm.

2. The laminate according to claim 1, wherein the laminate has two faces and a single said panel with the carrier provided with the polyester located on one or both of said faces.

3. The laminate according to claim 1, wherein the laminate comprises at least two said panels with the carrier provided with the polyester sandwiched between the two panels.

4. The laminate according to claim 1 wherein a total thickness of the one or more carriers, not including the polyester is less than 40% of the total thickness of the laminate, not including the polyester.

5. The laminate according to claim 1, wherein at least one of the one or more panels is of a different material than at least one of the one or more carriers.

6. The laminate according to claim 1, wherein the polycarboxylic acid comprises at least 10 wt. % of tricarboxylic acid, calculated based on a total amount of polyacid in the polyester.

7. A method for manufacturing the laminate according to claim 1, which method comprises steps of
providing the carrier provided with the polyester derived from the aliphatic polyol with 2-15 carbon atoms and the aliphatic polycarboxylic acid with 3 to 15 carbon atoms, the polyester having an extent of polymerization, which is a ratio of functional groups that have reacted to a maximum of those functional groups that can react, of at least 0.10, the carrier having an areal weight of 5-200 g/m², said areal weight not including the polyester,
applying said carrier onto the panel, to form the laminate of the panel and the carrier, said panel having a thickness of at least 0.2 mm, and
curing said laminate of the panel and the carrier.

8. A carrier provided with polyester, suitable for use in the method of claim 7, said carrier comprising a carrier material and a polyester derived from an aliphatic polyol with 2-15 carbon atoms and an aliphatic polycarboxylic acid with 3 to 15 carbon atoms or monomer precursors thereof, the polyester having an extent of polymerization, which is the ratio of the functional groups that have reacted to the maximum of those functional groups that can react, of at least 0.10, wherein the carrier has an areal weight of 5-200 g/m², said areal weight not including the polyester.

9. The carrier provided with the polyester according to claim 8, wherein the polyester is present on both sides of the carrier provided with the polyester, and the carrier makes up 2-70 wt. % of the total weight of the carrier and the polyester.

10. The carrier provided with the polyester according to claim 8, wherein the polyester is present on one side of the carrier, and another side of the carrier is free of the polyester.

11. A method for manufacturing the carrier provided with the polyester according to claim 8, comprising the steps of:
contacting the carrier material with a liquid medium comprising the polyester derived from the aliphatic polyol with 2-15 carbon atoms and the aliphatic polycarboxylic acid with 3 to 15 carbon atoms or the monomer precursors thereof, to form the carrier provided with the polyester or monomer precursors thereof, and
curing the carrier provided with the polyester or the monomer precursors thereof.

12. The method according to claim 11 for manufacturing the carrier provided with the polyester, wherein the carrier material is porous and the liquid medium is impregnated into the carrier material.

13. The method according to claim 11 for manufacturing the carrier provided with the polyester, wherein the carrier material is sufficiently flexible such that it can be rolled into a tube with a diameter of 5 cm or less followed by unrolling without being damaged.

14. The method according to claim 11 for manufacturing the carrier provided with the polyester, wherein the polyester in the liquid medium applied to the carrier material has an extent of polymerization, which is the ratio of the functional groups that have reacted to the maximum of those functional groups that can react, of between 0.1 and 0.6.

15. The method according to claim 11 for manufacturing the carrier provided with the polyester, wherein the carrier provided with the polyester or the monomer precursors thereof is cured to an extent of polymerization, which is the ratio of the functional groups that have reacted to the maximum of those functional groups that can react, of between 0.5 and 0.85.

16. The laminate of claim 1, wherein the extent of polymerization of the polyester, determined gravimetrically, is at least 0.8.

17. The laminate of claim 3, wherein one or both outer faces of the laminate are provided with the carrier provided with the polyester.

18. The laminate of claim 4, wherein the total thickness of the one or more carriers, not including the polyester is less than 25% of the total thickness of the laminate, not including the polyester.

19. The laminate of claim 6, wherein the polycarboxylic acid comprises at least 90 wt. % of tricarboxylic acid, calculated based on the total amount of polyacid in the polyester.

20. The laminate of claim 19, wherein the tricarboxylic acid comprises citric acid and/or the polyol consists of at least 50 mole % of glycerol, xylitol, sorbitol, or mannitol.
